(19) United States
(12) Patent Application Publication
(10) Pub. No.: US 2018/0285177 A1
(43) Pub. Date: Oct. 4, 2018

(54) Method of Detecting Damage and Scheduling Repair for a Portable Computing Device

(71) Applicant: Stanley Kvitko, Lafayette, CA (US)

(72) Inventor: Stanley Kvitko, Lafayette, CA (US)

(21) Appl. No.: 15/166,037

(22) Filed: May 26, 2016

Related U.S. Application Data
(60) Provisional application No. 62/167,057, filed on May 27, 2015.

(51) Int. Cl. G06F 11/07; G06Q 10/00; G06Q 30/00; G06Q 30/02; G06F 11/26; G06F 11/32; G06F 17/30

(52) U.S. Cl. CPC G06F 11/07; G06Q 10/20; G06Q 30/012; G06F 17/3087; G06F 11/26; G06F 11/321; G06Q 30/0269

(57) ABSTRACT

A method of detecting damage and scheduling repair for a portable computing device is used to detect damage to a portable computing device and expedite the process of repairing the portable computing device. In order for the method to be performed, a remote server and multiple portable computing devices are provided. The remote server manages a user profile for each of the portable computing devices. Each of the portable computing devices is monitored in order to detect a traumatic incident. This is done with an accelerometer which associates high accelerations with potential damage. Upon detecting a traumatic incident, a hardware status report is generated and used to determine whether each of a plurality of operational components are functioning properly. If a hardware malfunction is included in the hardware status report, the user is prompted to select a desired vendor from a list of potential vendors and schedule a repair request.

The current application claims a priority to the U.S. Provisional Patent application Ser. No. 62/167,057 filed on May 27, 2015.

### FIELD OF THE INVENTION

The present invention relates generally to methods for detecting and diagnosing damage done to portable computing devices. More particularly, the present invention relates to a method and system for automatically detecting damage done to a portable computing device and scheduling an appointment to repair the portable computing device.

### BACKGROUND OF THE INVENTION

Portable computing devices such as smartphones, tablets, and laptops are all subject to physical damage over the course of their respective product lifespans. Specifically, smartphones are especially prone to damage from being dropped and from general wear-and-tear. When damage occurs to a portable computing device it is important that the user is made aware of any damage that may have been caused to the portable computing device. For users who have a warranty or insurance on their portable computing devices, it is important for the user to fix the issue before coverage runs out. For operational components of the portable computing device which are housed within the device itself, it can be difficult to detect damage unassisted. If the user detects damage to their portable computing device, the process of finding a vendor to repair the portable computing device can be complicated, especially considering the fact that some vendors only have specialized experience with certain devices.

Accordingly, there is a present need for a system which may be used to detect any damage done to a portable computing device and guide the user of said device through the process of finding a repair vendor and scheduling the repair. The present invention involves monitoring portable computing devices until a traumatic incident is detected. This is done through measuring accelerations of the device with an accelerometer. Any acceleration that exceeds a predetermined threshold indicates a traumatic incident with the possibility of damage being done to the portable computing device. When a traumatic incident is recognized, a hardware status report is generated by performing functional tests on each of a plurality of operational components of the portable computing device. If a hardware malfunction is included with the hardware status report, the user is prompted to select a desired repair vendor and schedule a repair request.

### BRIEF DESCRIPTION OF THE DRAWINGS

FIG. 1 is a system diagram of the present invention.

FIG. 2 is a flow chart describing the general process of the present invention.

FIG. 3 is a flow chart describing the steps of generating a hardware status report using a user-derived function status for each of the operational components.

FIG. 4 is a flow chart describing the steps of retrieving the user-derived function status for a touchscreen.

FIG. 5 is a flow chart describing the steps of retrieving the user-derived function status for a device button.

FIG. 6 is a flow chart describing the steps of retrieving the user-derived function status for a camera.

FIG. 7 is a flow chart describing the steps of retrieving the user-derived function status for a gyroscope.

FIG. 8 is a flow chart describing the steps of retrieving the user-derived function status for an accelerometer.

FIG. 9 is a flow chart describing the steps of retrieving the user-derived function status for a proximity sensor.

FIG. 10 is a flow chart describing the steps of generating a hardware status report using a self-diagnosed function status for each of the operational components.

FIG. 11 is a flow chart describing the steps of detecting the traumatic incident using the accelerometer.

FIG. 12 is a flow chart describing the steps of detecting the traumatic incident using the gyroscope.

FIG. 13 is a flow chart describing the steps of generating a hardware status from receiving a checkup request.

FIG. 14 is a flow chart describing the steps of prompting the user to select a desired repair vendor by displaying a list of potential vendors.

FIG. 15 is a flow chart describing the steps of prompting the user to select a desired repair vendor by displaying a route and navigational instructions to the desired repair vendor.

FIG. 16 is a flow chart describing the steps of initiating step (C) after the arbitrary device transitions from the offline state to the online state.

### DETAILED DESCRIPTION OF THE INVENTION

All illustrations of the drawings are for the purpose of describing selected versions of the present invention and are not intended to limit the scope of the present invention.

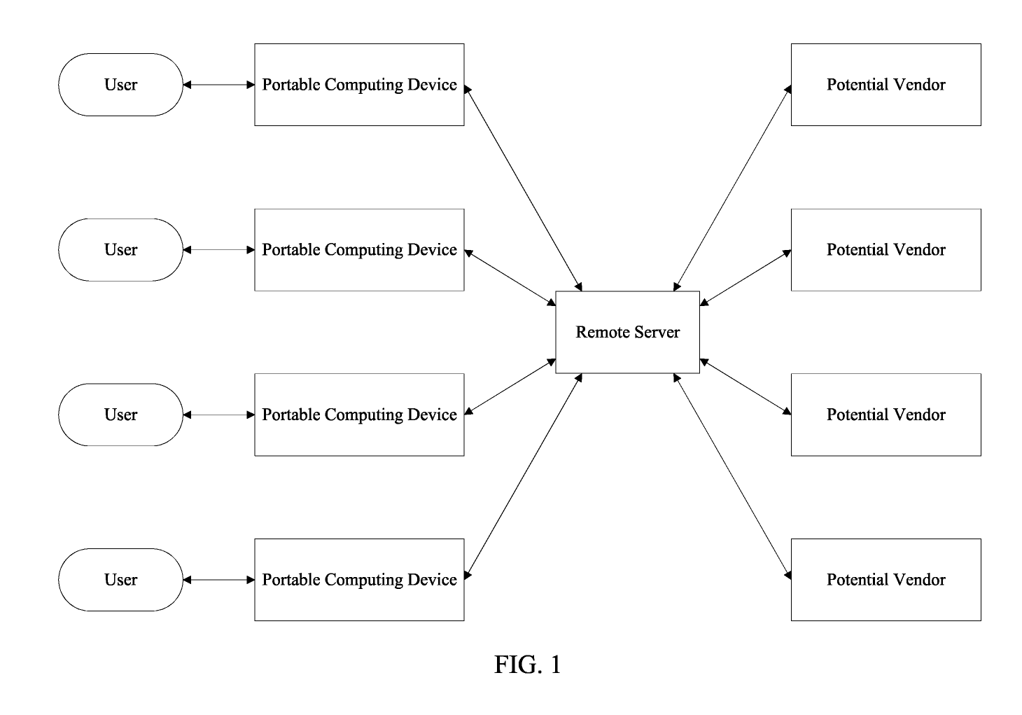

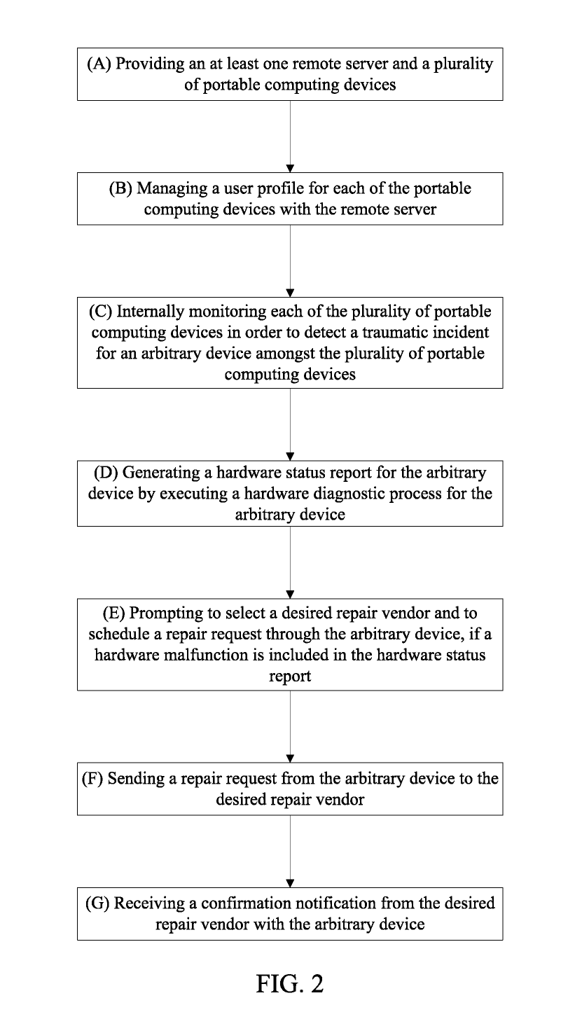

With reference to FIGS. 1-2, the present invention is a method of detecting damage and scheduling repair for a portable computing device. The present invention is used to detect any physical damage that may occur to a portable computing device and guide users through the process of scheduling the repair of said portable computing device. The method of the present invention is performed by a system in which at least one remote server and a plurality of portable computing devices are provided (Step A). The remote server is used to interact with each of the portable computing devices. The portable computing devices can include, but is not limited to, smartphones, tablets, and laptops. A user profile for each of the portable computing devices is managed with the remote server (Step B). The user profile contains information about the user and the user's portable computing device. Further, the user profile may store payment information and repair histories for the portable computing device.

Each of the plurality of portable computing devices is internally monitored in order to detect a traumatic incident for an arbitrary device amongst the plurality of portable computing devices (Step C). The detection of a traumatic incident corresponds with the possibility of physical damage being sustained by the arbitrary device. Accordingly, when a traumatic incident is detected, the arbitrary device should be inspected to determine if arbitrary device did, in fact, sustain damage. At the detection of a traumatic incident, a hardware status report is generated for the arbitrary device by executing a hardware diagnostic process for the arbitrary device (Step D). The hardware diagnostic process is used to determine functionality of each of the operational components of the arbitrary device. The hardware diagnostic process may include automatic tests or may guide the user through the process of inspecting the arbitrary device.

If a hardware malfunction is included in the hardware status report, the user is prompted to select a desired repair vendor and schedule a repair request through the arbitrary device (Step E). For users who may not be familiar with repair vendors in their area, this step can greatly simplify the process of finding and selecting the desired repair vendor. Upon scheduling the repair request, the repair request is sent from the arbitrary device to the desired repair vendor (Step F). The repair request includes date and time information and may also include information regarding the damage done to the arbitrary device. After the repair request is sent, a confirmation notification from the desired repair vendor is received with the arbitrary device (Step G). This is done to verify that the repair request has been properly scheduled and the arbitrary device is set to be fixed by the desired repair vendor.

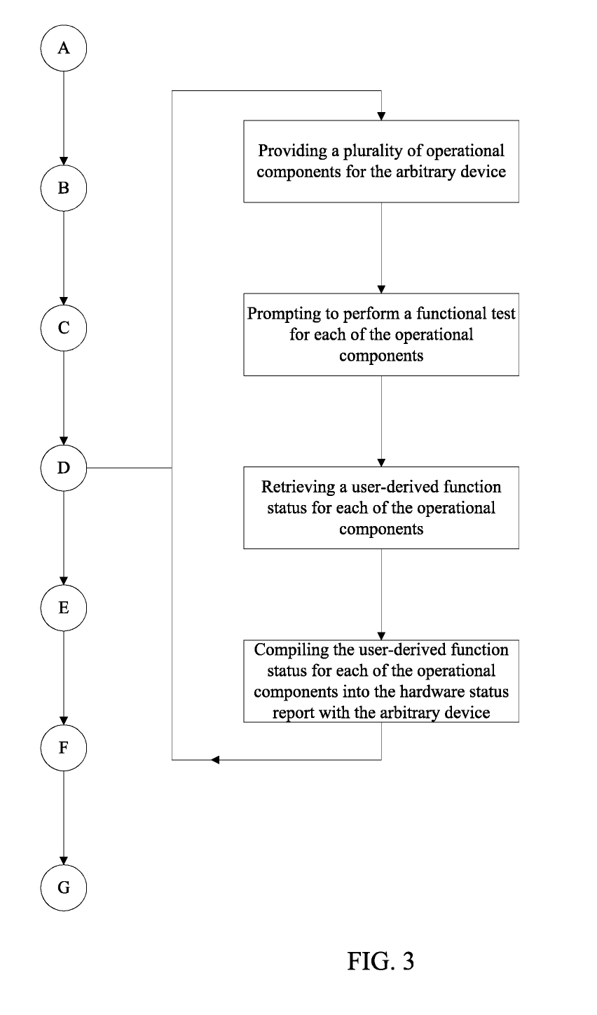

In reference to FIG. 3, a plurality of operational components is provided for the arbitrary device. While each operational component is designed to manage one or more functions of the arbitrary device, each operational component presents a potential point of failure for the arbitrary device. In the preferred embodiment of the present invention, the user is prompted to perform a functional test for each of the plurality of operational components if the traumatic incident is detected. A user-derived functional status is retrieved for each of the plurality of operational components. The user-derived functional status requires user input to determine if each operational component is functioning properly. The user-derived function status for each of the operational components is compiled into the hardware status report with the arbitrary device. As the hardware status report is populated with the user-derived function status for each operational component, the user is able to view each user-derived function status and determine if the arbitrary device is in need of repair.

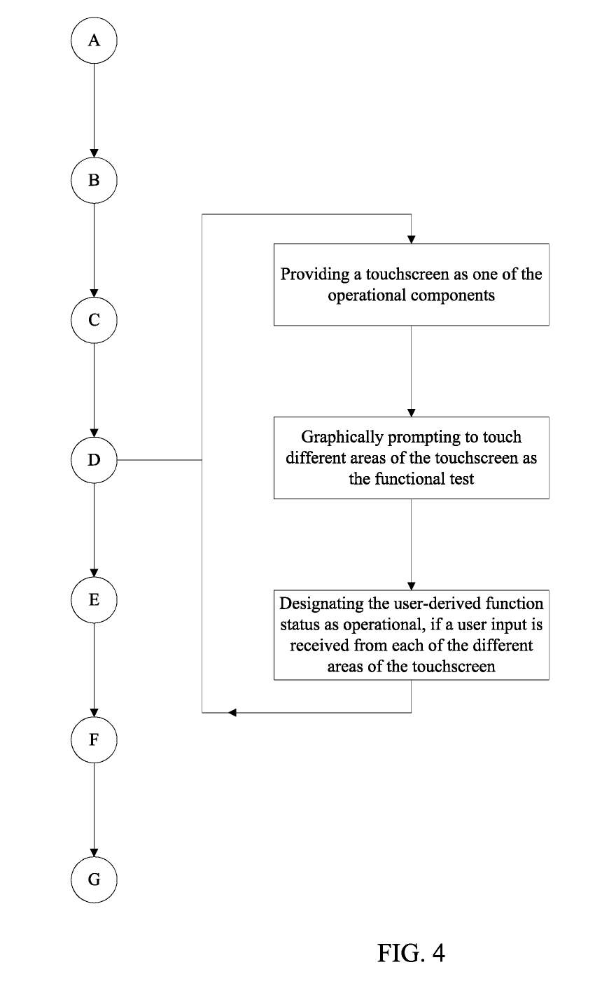

In the preferred embodiment of the present invention, a touchscreen is provided as one of the operational components. Like common smartphones and tablets, the touchscreen is used to display images and text for the user, while also providing a means for the user to interact with the arbitrary device. In order to perform the functional test, as shown in FIG. 4, the user is graphically prompted to touch different areas of the touchscreen. This functional test is ideal because the test can lead to determining if the touchscreen is not displaying correctly or if the touchscreen is not fully recognizing user interaction. If a user input is received from each of the different areas of the touchscreen, it can be concluded that the touchscreen is functioning as intended. Accordingly, the user-derived function status is designated as operational.

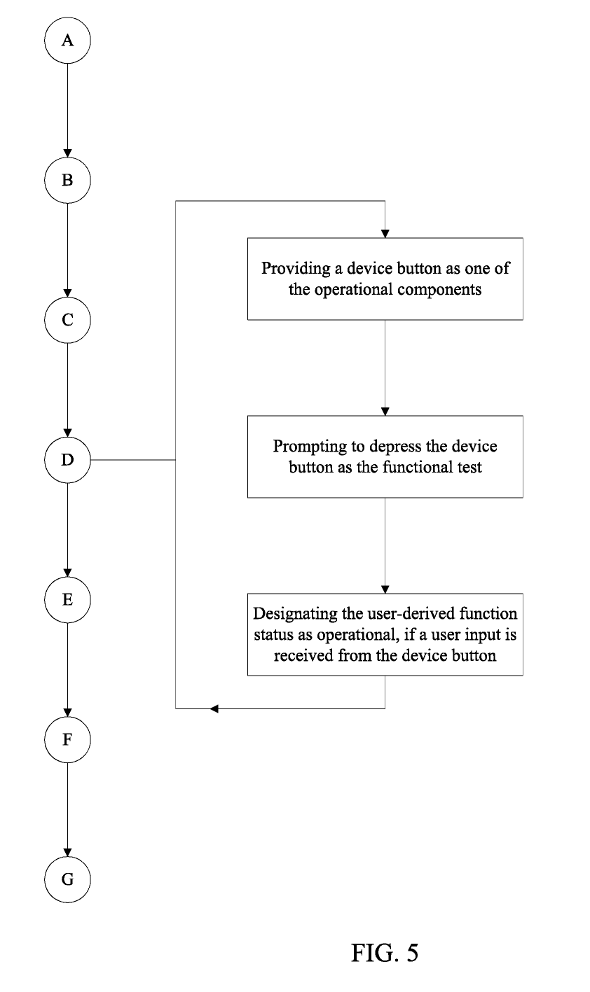

In the preferred embodiment of the present invention, a device button is also provided as one of the operational components. Depending on the exact type of device, the arbitrary device may have more than one device button. Device buttons have various uses, including but not limited to, volume control, sleep/wake control, and navigation to the home screen. In order to perform the functional test, as shown in FIG. 5, the user is prompted to depress the device button. If a user input is received from the device button, the user-derived function status is designated as operational. This process is used to quickly determine if a device button is operational and may be easily repeated for multiple device buttons, if applicable.

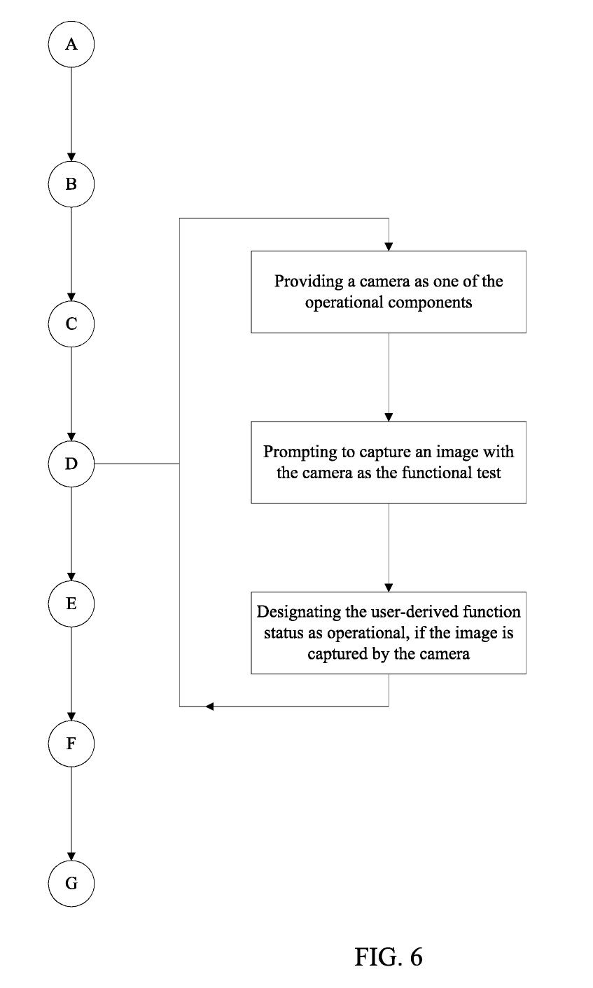

In the preferred embodiment of the present invention, a camera is provided as one of the operational components. In order to perform the functional test on the camera, as shown in FIG. 6, the user is prompted to capture an image with the camera. If the image is captured with the camera, the user-derived function status is designated as operational. In some situations, even if the camera is damaged, the camera may still be able to capture the image. To account for this, the functional test may further rely on the user to determine if the image is clear.

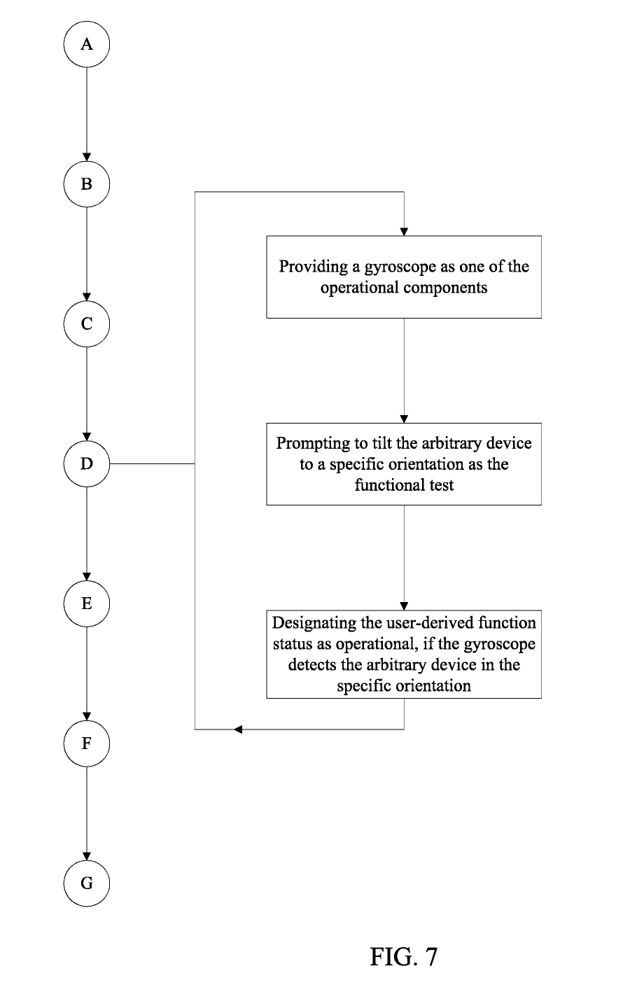

In the preferred embodiment of the present invention, a gyroscope is also provided as one of the operational components for the arbitrary device. The gyroscope is commonly used to determine the orientation of the arbitrary device, which may be necessary for games and other applications. In order to perform the functional test for the gyroscope, as shown in FIG. 7, the user is prompted to tilt the arbitrary device to a specific orientation. If the gyroscope detects the arbitrary device in the specific orientation, the user-derived function status is designated as operational. In the preferred embodiment of the present invention, the specific orientation is symbolized by an interface which prompts the user to navigate a ball through multiple points by tilting the arbitrary device. In an alternative embodiment, the specific orientation may simply involve tilting the arbitrary device away from its current orientation.

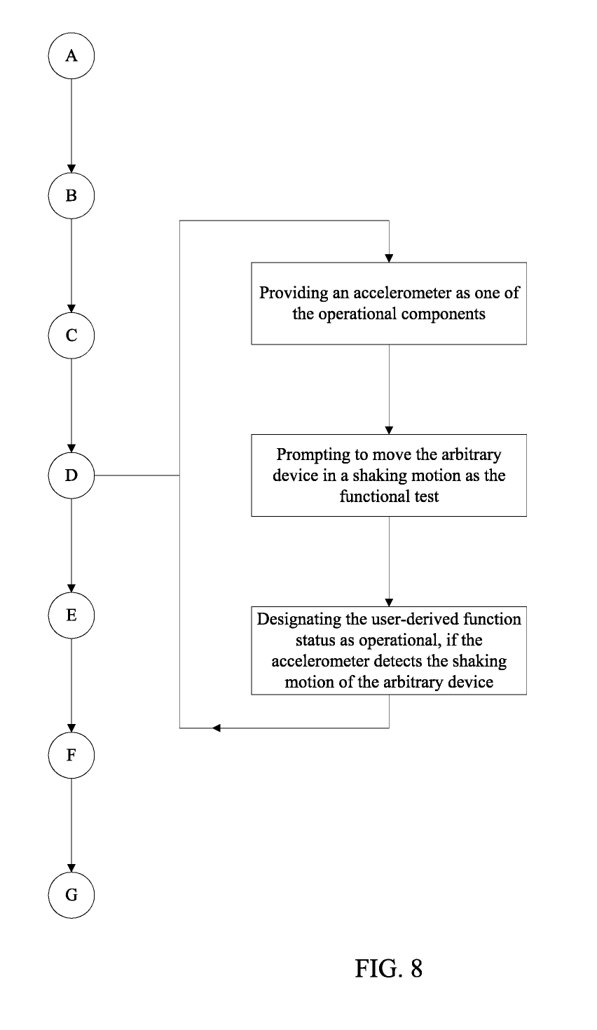

In the preferred embodiment of the present invention, an accelerometer is provided as one of the operational components. The accelerometer is commonly used to measure accelerations of the arbitrary device for games and other applications. In order to perform the functional test for the accelerometer, as shown in FIG. 8, the user is prompted to move the arbitrary device in a shaking motion. If the accelerometer detects the shaking motion of the arbitrary device, the user-derived function status is designated as operational. Depending on the complexity of the accelerometer, the user may be prompted to shake the arbitrary device in various directions to insure that the accelerometer is fully functional.

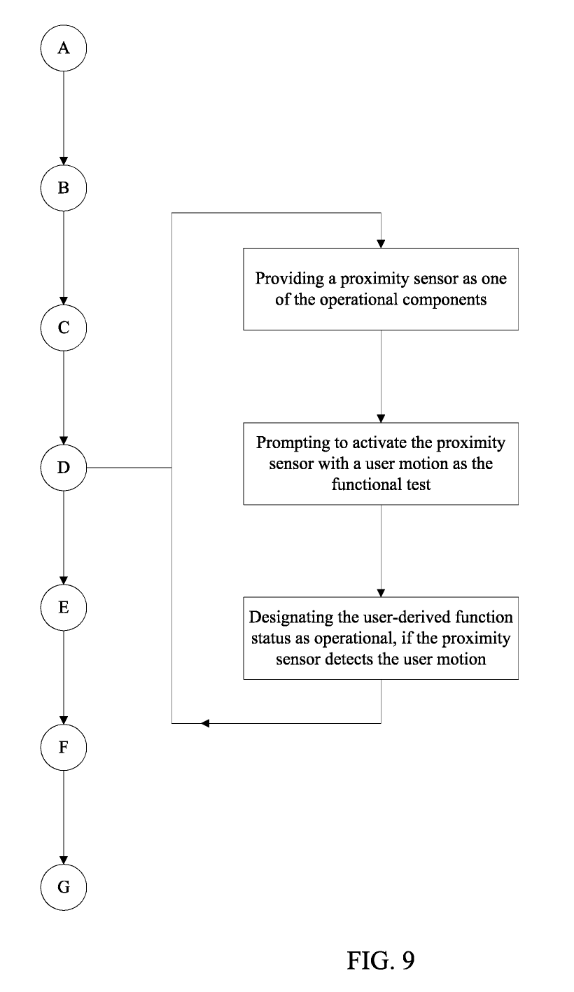

A proximity sensor is also provided as one of the operational components. The proximity sensor is commonly used to detect the user's ear during a call so that the touchscreen may be deactivated. Further, the proximity sensor may be used to trigger the activation of the touch screen if the user is reaching for the arbitrary device. In order to perform the functional test on the proximity sensor, as shown in FIG. 9, the user is prompted to activate the proximity sensor with a user motion. In the preferred embodiment of the present invention, the user motion involves waving a hand near the arbitrary device; however, other types of user motions may alternatively be used. If the proximity sensor detects the user motion, it can be concluded that the proximity sensor is functioning properly. Accordingly, the user-derived function status for the proximity sensor is designated as operational.

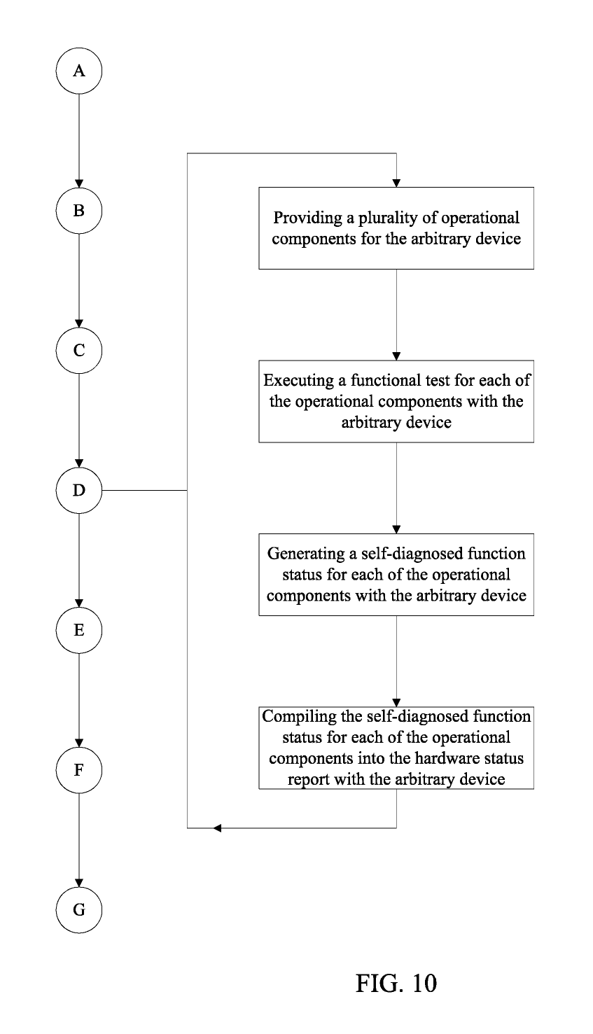

In an alternative embodiment of the present invention, the functional test for each of the plurality of operational components is executed with the arbitrary device. This involves no user interaction, eliminating the possibility for user error. In this embodiment, shown in FIG. 10, a self-diagnosed function status for each of the plurality of operational components is generated with the arbitrary device. The self-diagnosed function status for each of the plurality of operational components is compiled into the hardware status report with the arbitrary device. As the hardware status report is populated with the self-diagnosed function status for each operational component, the user is able to view each self-diagnosed function status and determine if the arbitrary device is in need of repair.

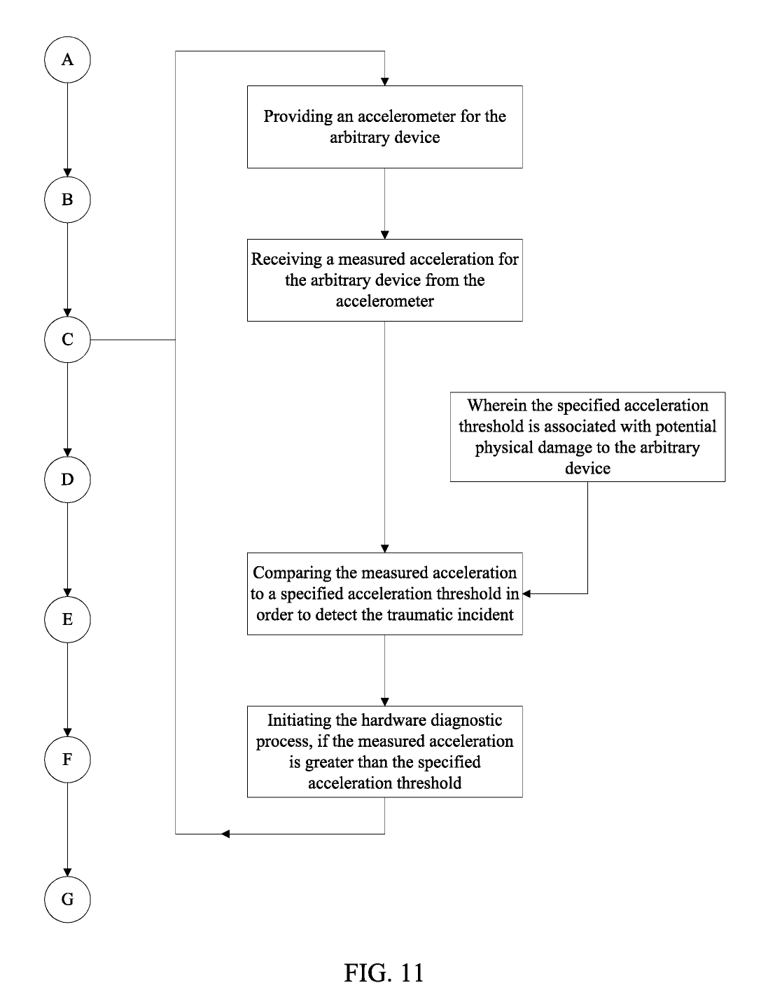

In the preferred embodiment of the present invention, the accelerometer is used to detect the traumatic incident. In order to detect a traumatic incident, as shown in FIG. 11, a measured acceleration for the arbitrary device is received from the accelerometer. The measured acceleration is compared to a specified acceleration threshold in order to detect the traumatic incident. The specified acceleration threshold is associated with potential physical damage to the arbitrary device. If the measured acceleration is greater than the specified acceleration threshold, the hardware diagnostic process is initiated. Measured accelerations may be repeatedly taken in order to constantly monitor the arbitrary device.

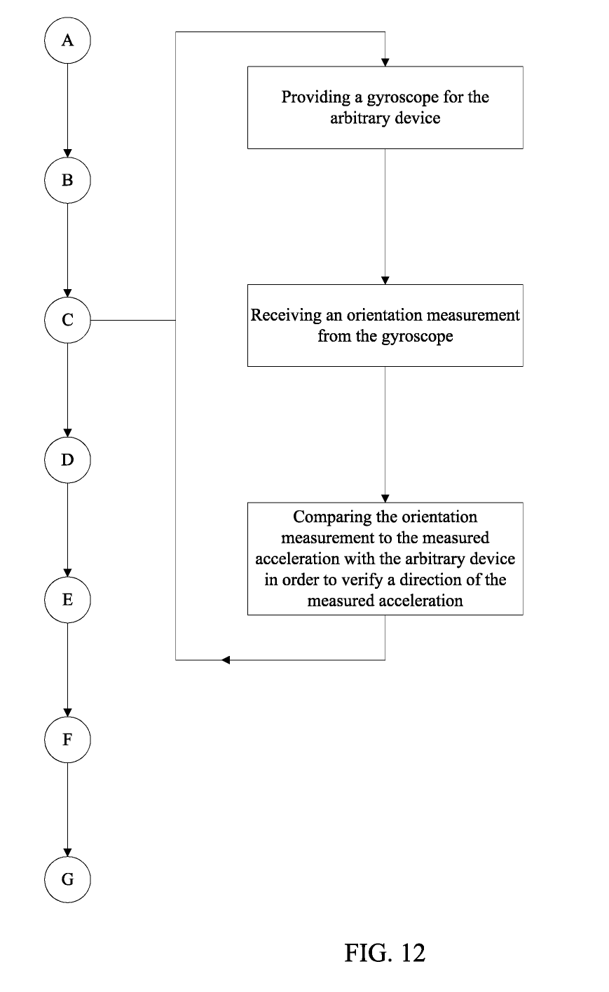

In addition to the accelerometer, the gyroscope may also be used to aid in the detection of the traumatic incident. To do so, an orientation measurement is received from the gyroscope. In reference to FIG. 12, the arbitrary device is then used to compare the orientation measurement to the measured acceleration in order to verify a direction of the measured acceleration. By verifying the direction of the measured acceleration, the arbitrary device is able to confirm that the arbitrary device is moving and or rotating.

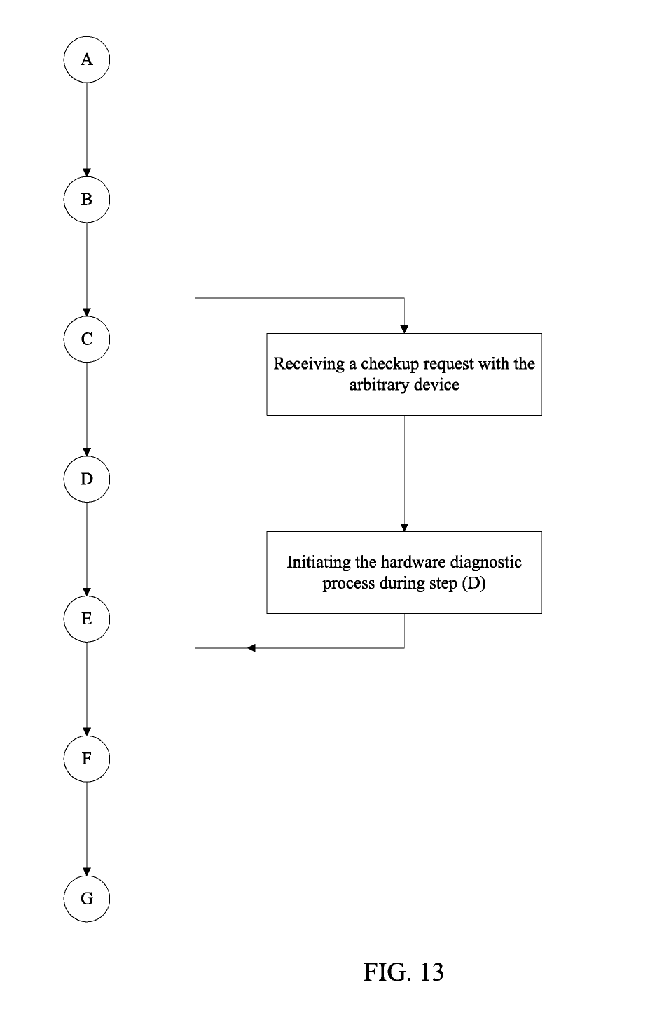

In case the user experiences one or more problems with the arbitrary device and a traumatic incident has not been detected, the user has the option to trigger the hardware diagnostic process manually. In reference to FIG. 13, the user may choose to request a checkup for the arbitrary device. When a checkup request is received with the arbitrary device, the hardware diagnostic process is initiated during step (D). This functionality may be useful when dealing with water damage, overheating, or any difficult to detect malfunction of one or more operational component.

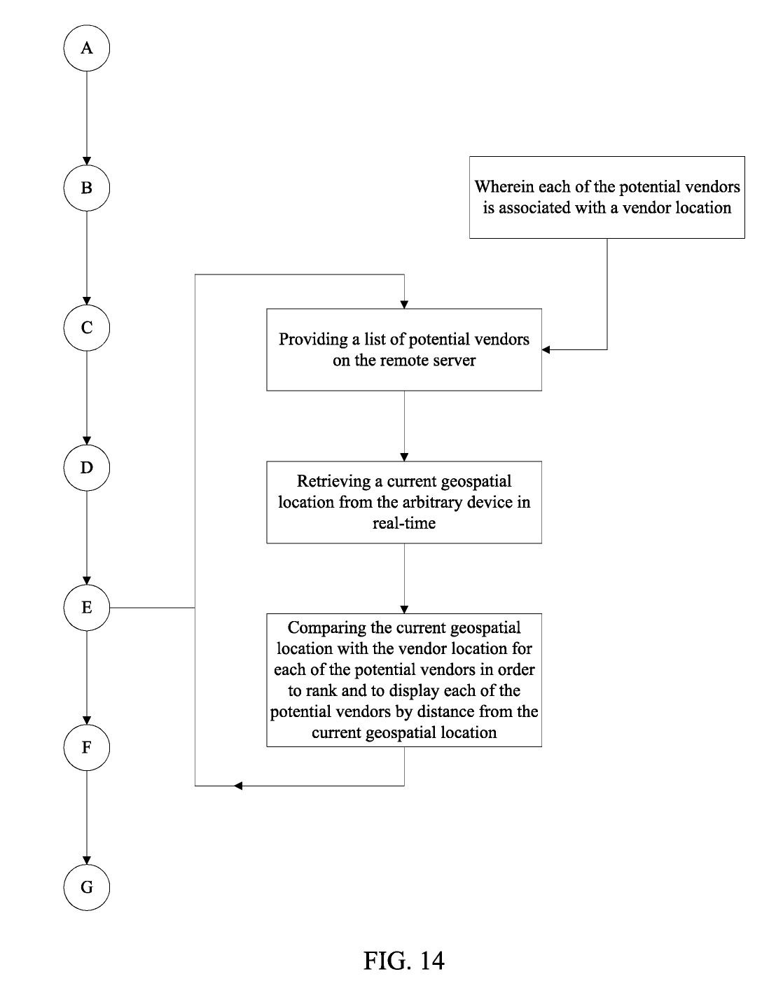

If a hardware malfunction is included in the hardware status report, the present invention may be used to guide the user through the process of finding a desired repair vendor. In reference to FIG. 14, a list of potential vendors is provided on the remote server. The list of potential vendors can include vendors that specialize in fixing various types of devices or may even be vendors of accessories or protective gear for portable computing devices. Each of the potential vendors is associated with a vendor location. The vendor location details where the user must go to have the arbitrary device fixed. For some users, the vendor location may be a factor in choosing a desired repair vendor. A current geospatial location is retrieved from the arbitrary device in real-time and is used to determine the current location of the user. The current geospatial location is compared with the vendor location for each of the potential vendors in order to rank and display each of the potential vendors by distance from the current geospatial location. This allows the user to see how far each of the potential vendors are from their current location and determine the closest potential vendors which can fix the arbitrary device.

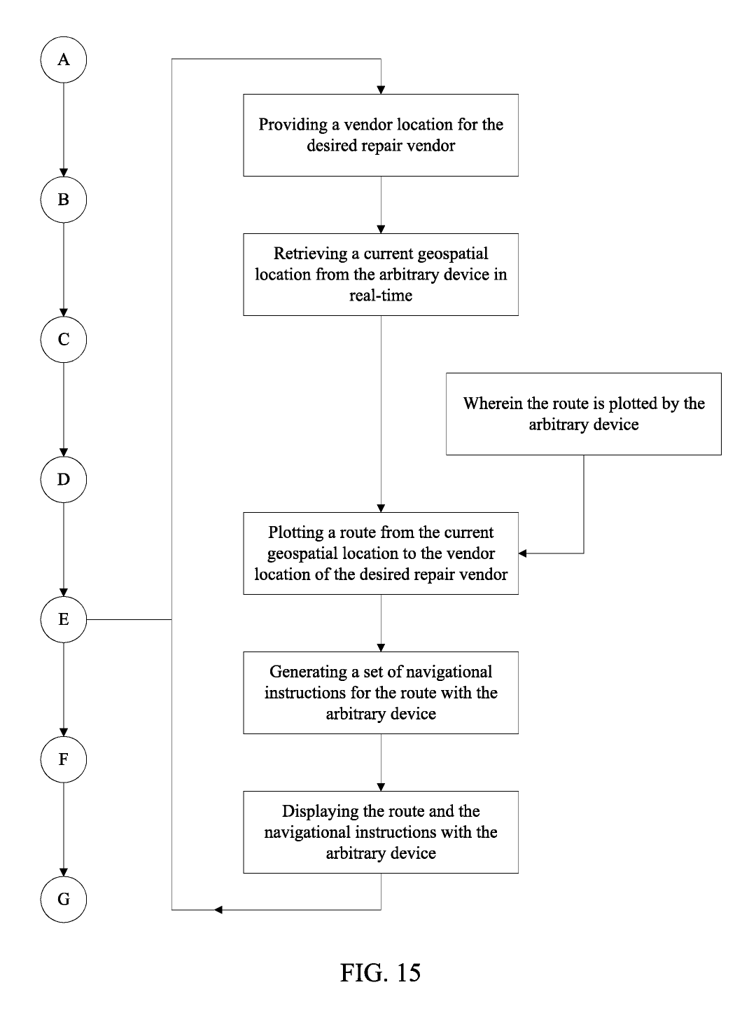

In reference to FIG. 15, when the user selects a desired repair vendor, a route is plotted by the arbitrary device from the current geospatial location to the vendor location of the desired repair vendor. The plotted route is used to visually depict how the user is to get to the vendor location for the desired repair vendor. In addition, a set of navigational instructions is generated for the route with the arbitrary device. The route and the navigational instructions are displayed together with the arbitrary device in order to guide the user to the desired repair vendor. Like common global positioning systems (GPS's), the route and navigational instructions may be recalculated in the event that the user strays from the route.

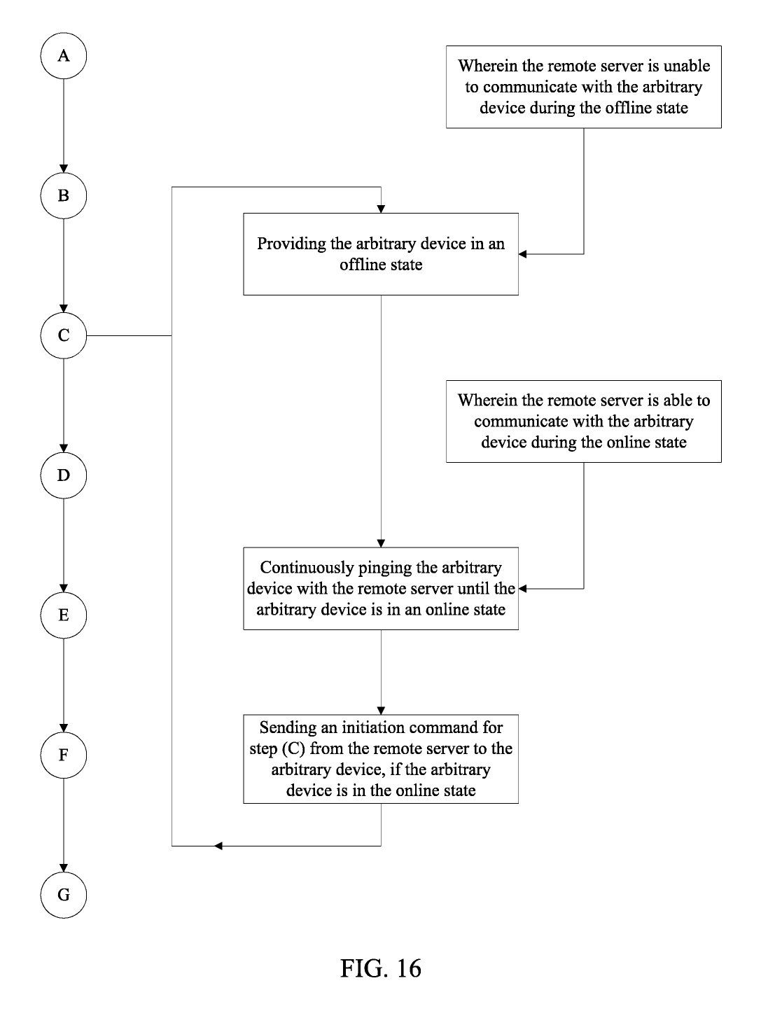

The method of the present invention is intended to run continuously in the background of the arbitrary device. However, if the arbitrary device is turned off or runs out of battery, the method of the present invention cannot be performed. In reference to FIG. 16, this occurs when the arbitrary device is in an offline state, wherein the remote server is unable to communicate with the arbitrary device during the offline state. If the arbitrary device is in the offline state, the remote server continuously pings the arbitrary device until the arbitrary device is in an online state. In contrast to the offline state, the online state is characterized by the remote server being able to communicate with the arbitrary device. If the arbitrary device is in the online state, an initiation command for step (C) is sent from the remote server to the arbitrary device. This is done to automatically resume the method of the present invention once the arbitrary returns to the online state.

Although the invention has been explained in relation to its preferred embodiment, it is to be understood that many other possible modifications and variations can be made without departing from the spirit and scope of the invention as hereinafter claimed.

1. A method of detecting damage and scheduling repair for a portable computing device, the method comprises the steps of:
(A) providing an at least one remote server and a plurality of portable computing devices;
(B) managing a user profile for each of the portable computing devices with the remote server;
(C) internally monitoring each of the plurality of portable computing devices in order to detect a traumatic incident for an arbitrary device amongst the plurality of portable computing devices;
(D) generating a hardware status report for the arbitrary device by executing a hardware diagnostic process for the arbitrary device;
(E) prompting to select a desired repair vendor and to schedule a repair request through the arbitrary device, if a hardware malfunction is included in the hardware status report;
(F) sending a repair request from the arbitrary device to the desired repair vendor; and
(G) receiving a confirmation notification from the desired repair vendor with the arbitrary device.

2. The method of detecting damage and scheduling repair for a portable computing device as claimed in claim 1 comprises:
providing a plurality of operational components for the arbitrary device;
prompting to perform a functional test for each of the plurality of operational components;
retrieving a user-derived function status for each of the plurality of operational components; and
compiling the user-derived function status for each of the operational components into the hardware status report with the arbitrary device.

3. The method of detecting damage and scheduling repair for a portable computing device as claimed in claim 2 comprises:
providing a touchscreen as one of the operational components;
graphically prompting to touch different areas of the touchscreen as the functional test; and
designating the user-derived function status as operational, if a user input is received from each of the different areas of the touchscreen.

4. The method of detecting damage and scheduling repair for a portable computing device as claimed in claim 2 comprises:
providing a device button as one of the operational components;
prompting to depress the device button as the functional test; and
designating the user-derived function status as operational,
if a user input is received from the device button.

5. The method of detecting damage and scheduling repair for a portable computing device as claimed in claim 2 comprises:
providing a camera as one of the operational components;
prompting to capture an image with the camera as the functional test; and
designating the user-derived function status as operational,
if the image is captured by the camera.

6. The method of detecting damage and scheduling repair for a portable computing device as claimed in claim 2 comprises:
providing a gyroscope as one of the operational components;
prompting to tilt the arbitrary device to a specific orientation as the functional test; and
designating the user-derived function status as operational,
if the gyroscope detects the arbitrary device in the specific orientation.

7. The method of detecting damage and scheduling repair for a portable computing device as claimed in claim 2 comprises:
providing an accelerometer as one of the operational components;
prompting to move the arbitrary device in a shaking motion as the functional test; and
designating the user-derived function status as operational,
if the accelerometer detects the shaking motion of the arbitrary device.

8. The method of detecting damage and scheduling repair for a portable computing device as claimed in claim 2 comprises:
providing a proximity sensor as one of the operational components;
prompting to activate the proximity sensor with a user motion as the functional test; and
designating the user-derived function status as operational,
if the proximity sensor detects the user motion.

9. The method of detecting damage and scheduling repair for a portable computing device as claimed in claim 1 comprises:
providing a plurality of operational components for the arbitrary device;
executing a functional test for each of the operational components with the arbitrary device;
generating a self-diagnosed function status for each of the operational components with the arbitrary device; and
compiling the self-diagnosed function status for each of the operational components into the hardware status report with the arbitrary device.

10. The method of detecting damage and scheduling repair for a portable computing device as claimed in claim 1 comprises:
providing an accelerometer for the arbitrary device;
receiving a measured acceleration for the arbitrary device from the accelerometer;
comparing the measured acceleration to a specified acceleration threshold in order to detect the traumatic incident, wherein the specified acceleration threshold is associated with potential physical damage to the arbitrary device; and
initiating the hardware diagnostic process,
if the measured acceleration is greater than the specified acceleration threshold.

11. The method of detecting damage and scheduling repair for a portable computing device as claimed in claim 1 comprises:
receiving a checkup request with the arbitrary device; and
initiating the hardware diagnostic process during step (D).

12. The method of detecting damage and scheduling repair for a portable computing device as claimed in claim 1 comprises:
providing a list of potential vendors on the remote server, wherein each of the potential vendors is associated with a vendor location;
retrieving a current geospatial location from the arbitrary device in real-time; and
comparing the current geospatial location with the vendor location for each of the potential vendors in order to rank and to display each of the potential vendors by distance from the current geospatial location.

13. The method of detecting damage and scheduling repair for a portable computing device as claimed in claim 1 comprises:
providing a vendor location for the desired repair vendor;
retrieving a current geospatial location from the arbitrary device in real-time;
plotting a route from the current geospatial location to the vendor location of the desired repair vendor, wherein the route is plotted by the arbitrary device;
generating a set of navigational instructions for the route with the arbitrary device; and
displaying the route and the navigational instructions with the arbitrary device.

14. The method of detecting damage and scheduling repair for a portable computing device as claimed in claim 1 comprises:
providing the arbitrary device in an offline state, wherein the remote server is unable to communicate with arbitrary device during the offline state;
continuously pinging the arbitrary device with the remote server, until the arbitrary device is in an online state, wherein the remote server is able to communicate with arbitrary device during the online state; and
sending an initiation command for step (C) from the remote server to the arbitrary device, if the arbitrary device is in the online state.

15. The method of detecting damage and scheduling repair for a portable computing device as claimed in claim 10 comprises:
providing a gyroscope for the arbitrary device;
receiving an orientation measurement from the gyroscope; and
comparing the orientation measurement to the measured acceleration with the arbitrary device in order to verify a direction of the measured acceleration.
